(19) United States
(12) Patent Application Publication
(10) Pub. No.: US 2017/0195713 A1
(43) Pub. Date: Jul. 6, 2017

(54) METHOD AND ELECTRONIC DEVICE FOR UNLIMITEDLY SLIDING TO SWITCH CHANNELS

(71) Applicants: Le Holdings (Beijing) Co., Ltd., Beijing (CN); Le Shi Internet Information & Technology Corp., Beijing, Beijing (CN)

(72) Inventor: Wei YANG, Beijing (CN)

(21) Appl. No.: 15/246,462

(22) Filed: Aug. 24, 2016

Related U.S. Application Data
(63) Continuation of application No. PCT/CN2016/089312, filed on Jul. 8, 2016.

(30) Foreign Application Priority Data
Dec. 31, 2015 (CN) 201511032404.X

(51) Int. Cl. H04N 21/438; H04N 21/482; H04N 21/45; H04N 21/488; H04N 21/466; H04N 21/2187; H04N 21/472

(52) U.S. Cl. CPC H04N 21/4383; H04N 21/2187; H04N 21/4826; H04N 21/472; H04N 21/4882; H04N 21/4668; H04N 21/4532; H04N 21/858

(57) ABSTRACT

A method and an electronic device for unlimitedly sliding to switch channels. The method includes: detecting that a trigger event occurs on a live broadcast interface; sending a preset live broadcast channel list request to a server and receiving a preset live broadcast channel list from the server; if the trigger event is an instruction for acquiring new content, judging whether a current live broadcast channel is a last live broadcast channel in the preset live broadcast channel list; if the current live broadcast channel is not the last live broadcast channel in the preset live broadcast channel, switching to a next live broadcast channel for live broadcast; if the current live broadcast channel is the last live broadcast channel in the preset live broadcast channel, sending a first recommended live broadcast channel list request and receiving the first recommended live broadcast channel list request; and broadcasting corresponding live broadcast channels according to a sequence in the first recommended live broadcast channel list.

### CROSS REFERENCE TO RELATED APPLICATIONS

The present disclosure is a continuation application of PCT International patent application No. PCT/CN2016/089312, filed on Jul. 8, 2016, which claims priority to Chinese Patent Application No. 201511032404.X, filed with the Chinese Patent Office on Dec. 31, 2015, both of which are herein incorporated by reference in their entireties.

### TECHNICAL FIELD

The present disclosure relates to the technical field of media data processing, and more particularly, to a method and an electronic device for unlimitedly sliding to switch channels.

### BACKGROUND

Live broadcast of network videos is one of the main functions of various large video websites and video software. With this function, users are capable of watching some on-site live broadcast programs, matches and the like over the network. To enhance user experience, generally in a live broadcast interface, switching of live broadcast channels may be implemented by a gesture operation.

### SUMMARY

An embodiment of the present disclosure provides a method for unlimitedly sliding to switch channels, which is applied to a terminal, including:

detecting that a trigger event occurs on a live broadcast interface;

sending a preset live broadcast channel list request to a server and receiving a preset live broadcast channel list from the server;

determining whether a current live broadcast channel is a last live broadcast channel in the preset live broadcast channel list, if the trigger event is an instruction for acquiring new content;

switching to a next live broadcast channel for live broadcast, if the current live broadcast channel is not the last live broadcast channel in the preset live broadcast channel;

sending a first recommended live broadcast channel list request to the server and receiving a first recommended live broadcast channel list from the server, if the current live broadcast channel is the last live broadcast channel in the preset live broadcast channel; and

broadcasting corresponding live broadcast channels according to a sequence in the first recommended live broadcast channel list.

Another embodiment of the present disclosure provides a method for unlimitedly switching channels, which is applied to a server, including:

receiving a preset live broadcast channel list request and returning a preset live broadcast channel list;

receiving a first recommended live broadcast channel list request, the first recommended live broadcast channel list request carrying user information; and

generating a first recommended live broadcast channel list according to the user information corresponding to the first recommended live broadcast channel list request, and returning the first recommended live broadcast channel list.

An embodiment of the present disclosure further provides an electronic device 1, the electronic device includes: at least one processor, and a memory. The memory is communicably connected with the at least one processor and for storing instructions executable by the at least one processor. Wherein execution of the instructions by the at least one processor causes the at least one processor to:

detect that a trigger event occurs on a live broadcast interface;

send a preset live broadcast channel list request to a server and receive a preset live broadcast channel list from the server, and if a current live broadcast channel is a last live broadcast channel, send a first recommended live broadcast channel list request to the server and receive a first recommended live broadcast channel list from the server;

determine whether the current live broadcast channel is the last live broadcast channel in the preset live broadcast channel list, if the trigger event is an instruction for acquiring new content; and

switch to a next live broadcast channel for live broadcast, if the current live broadcast channel is not the last live broadcast channel in the preset live broadcast channel, and live broadcast corresponding live broadcast channels according to a sequence in the first recommended live broadcast channel list, if the current live broadcast channel is the last live broadcast channel in the predetermined live broadcast channel.

An embodiment of the present disclosure further provides an electronic device 1, the electronic device includes: at least one processor, and a memory. The memory is communicably connected with the at least one processor and for storing instructions executable by the at least one processor. Wherein execution of the instructions by the at least one processor causes the at least one processor to:

receive a preset live broadcast channel list request and return a preset live broadcast channel list;

receive a first recommended live broadcast channel list request, the first recommended live broadcast channel list request carrying user information; and

generate a first recommended live broadcast channel list according to the user information corresponding to the first recommended live broadcast channel list request, and return the first recommended live broadcast channel list.

### BRIEF DESCRIPTION OF THE DRAWINGS

To describe embodiments of the present disclosure or the technical solution in the related art, hereinafter, drawings that are to be referred for description of the embodiments or the related art are briefly described. Apparently, the drawings described hereinafter merely illustrate some embodiments of the present disclosure. Persons of ordinary skill in the art may also derive other drawings based on the drawings described herein without any creative effort.

FIG. 1 is a schematic flowchart illustrating a method for unlimitedly sliding to switch channels according to one embodiment of the present disclosure;

FIG. 2 is a schematic flowchart illustrating a method for unlimitedly sliding to switch channels according to another embodiment of the present disclosure;

FIG. 3 is a schematic structural diagram illustrating a terminal for unlimitedly sliding to switch channels in terms of modules according to one embodiment of the present disclosure;

FIG. 4 is a schematic structural diagram illustrating a server for unlimitedly sliding to switch channels in terms of modules according to one embodiment of the present disclosure;

FIG. 5 is a schematic diagram of an interface when first prompt information according to the method and apparatus embodiments for unlimitedly sliding to switch channels according to the present disclosure;

FIG. 6 is a schematic diagram of an interface when second prompt information according to the method and apparatus embodiments for unlimitedly sliding to switch channels according to the present disclosure; and

FIG. 7 is a schematic diagram of an interface when third prompt information according to the method and apparatus embodiments for unlimitedly sliding to switch channels according to the present disclosure;

FIG. 8 is a schematic block diagram illustrating a terminal for unlimitedly switching channels according to an embodiment of the present disclosure;

FIG. 9 is a schematic block diagram illustrating a server for unlimitedly switching channels according to an embodiment of the present disclosure.

### DETAILED DESCRIPTION

To make the objectives, technical solutions, and advantages of the present disclosure clearer, the present disclosure is described in detail with reference to the accompanying drawings and specific embodiments.

It should be noted that, the terms “first” and “second” used in the embodiments of the present disclosure are two non-identical entities or non-identical parameters having the identical name. It is apparent that the terms “first” and “second” are given herein for illustration convenience, and shall not be construed as limiting the embodiments of the present disclosure. Such terms are not described in the following embodiments any further.

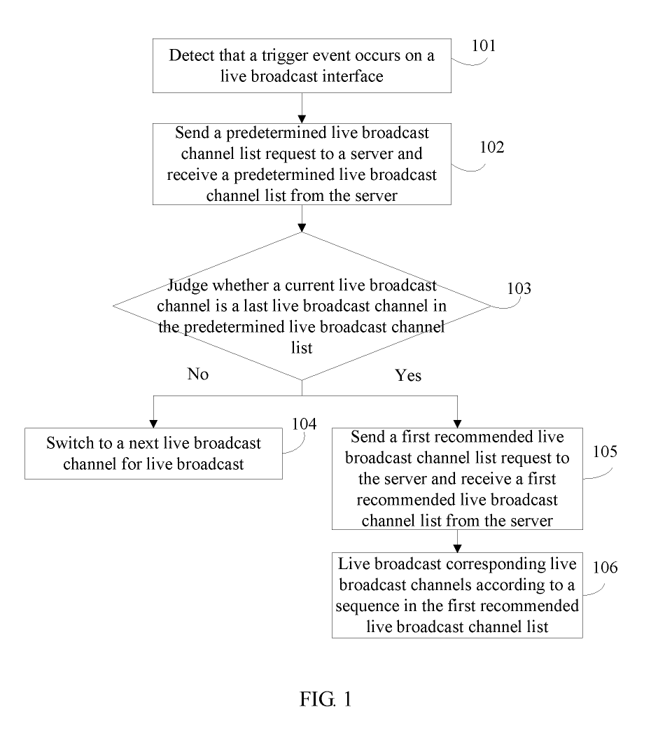

One exemplary embodiment of the present disclosure provides a method capable of implementing unlimitedly sliding to switch of channels. As illustrated in FIG. 1, a schematic flowchart illustrating a method for unlimitedly sliding to switch channels according to one embodiment of the present disclosure is given.

The method for unlimitedly sliding to switch channels includes the following steps:

In Step 101: a trigger event occurs in a live broadcast interface is detected. For example, a touch signal applied to the live broadcast interface may be acquired via a touch screen of a device, or in another manner, for example, by means of clicking a button or a control signal sent by a remote control.

In Step 102: A preset live broadcast channel list request is sent to a server and a preset live broadcast channel list received from the server.

In step 103: If the trigger event is an instruction for acquiring new content, it is determined whether a current live broadcast channel is a last live broadcast channel in the preset live broadcast channel list; wherein the instruction for acquiring the new content may be sent by a user via a touch gesture, or may be sent by means of clicking a button or a remote control; and in one exemplary embodiment, the gesture corresponding to the instruction for acquiring the new content may be swiping from the right to the left if the instruction is sent via a touch gesture.

In some exemplary embodiments, the live broadcast channels are live broadcasted in a sequence in a preset live broadcast channel list corresponding to the categories of the channels (for example, sports, entertainment and the like categories); wherein the last live broadcast channel may optionally refer to the last live broadcast channel in the preset live broadcast channel list or the last unwatched live broadcast channel in the preset live broadcast channel list. Herein, when the live broadcast channel entering live broadcast is a live broadcast channel in the intermediate portion of the preset live broadcast channel list, instead of the first live broadcast channel in the preset live broadcast channel list, after switching is made to the last live broadcast channel in the preset live broadcast channel list, since the live broadcast channels in the front portion of the preset live broadcast channel list are not broadcast, the last unwatched live broadcast channel refers to a live broadcast channel prior to the live broadcast channel entering live broadcast in the preset live broadcast channel list. The preset live broadcast channel list is acquired from the server after the preset live broadcast channel list request is sent to the server.

In Step 104: If the current live broadcast channel is not the last live broadcast channel in the preset live broadcast channel list, switching is made to a next live broadcast channel for live broadcast; wherein the last live broadcast channel may be optionally the last live broadcast in the preset live broadcast channel list or the last unwatched live broadcast channel in the preset live broadcast channel list.

In Step 105: If the current live broadcast channel is the last live broadcast channel in the preset live broadcast channel, a first recommended live broadcast channel list request is sent to the server and a first recommended live broadcast channel list is received from the server; wherein the last live broadcast channel may be optionally the last live broadcast in the preset live broadcast channel list or the last unwatched live broadcast channel in the preset live broadcast channel list; and in one exemplary embodiment, the first recommended live broadcast channel list is recommended to the user via a recommendation system according to the user's interests.

In Step 106: Corresponding live broadcast channels are live broadcast according to a sequence in the first recommended live broadcast channel list.

As seen from the above, with the method for unlimitedly sliding to switch channels, it is determined whether a user needs to acquire new content by detecting a trigger event; if the user needs to acquire the new content, it is determined whether a current live broadcast channel is a last live broadcast channel (that is, no more content may be provided subsequently); and if the current live broadcast channel is the last live broadcast channel, content of other live broadcast channels in which the user may be interested may be recommended to the user, such that more and richer content is exposed to the user. This achieves the objective of unlimitedly sliding to switch channels, increases use duration and retention of the user and enhances user experience.

Further, in some exemplary embodiments, the step 104 of switching to a next live broadcast channel for live broadcast, the method may further include the following steps:

It is determined whether the live broadcast channel switched is the last live broadcast channel in the preset live broadcast channel list; wherein the judging whether the live broadcast channel switched is the last live broadcast channel may be performed by using the method as described in the above embodiment, which is thus not described herein any further;

if the live broadcast channel switched is the last live broadcast channel, a current interface style is changed and/or first prompt information 501 is sent.

The changing the current interface style may be switching the theme of the current interface and selecting a theme which has a prominent color and color matching, thereby achieving the effect of prompting. As illustrated in FIG. 5, the text prompt may employ lighter colors or be subjected to transparent treatment, to ensuring watching quality for the user.

After switching of the live broadcast channel, it is determined whether the current live broadcast channel is the last live broadcast channel, and when it is determined that the current live broadcast channel is the last live broadcast channel, the user is prompted that the current live broadcast channel is the last broadcast channel and content would be provided for the user in case of further channel switching, thereby guiding the user to watch the recommended content and facilitating user's watching.

In some exemplary embodiments, prior to the step 106 of broadcasting corresponding live broadcast channels according to a sequence in the first recommended live broadcast channel list, the method may further include the following steps:

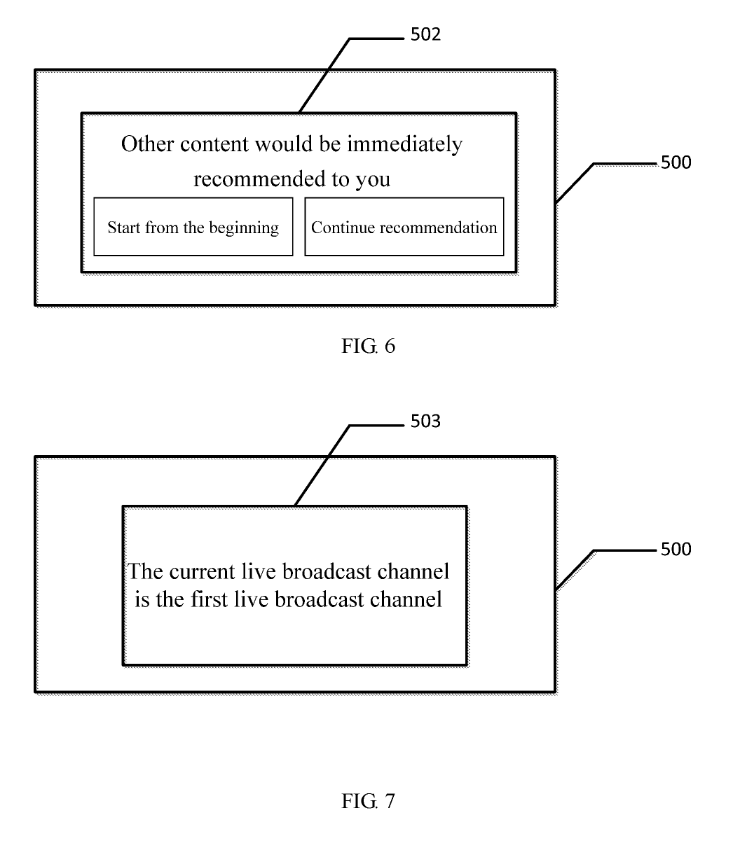

second prompt information 502 is sent (as illustrated in FIG. 6) for prompting the user that a live broadcast channel would be recommended if the user further switches the channel, and whether an instruction for returning to a first live broadcast channel is received or a recommendation instruction for acquiring a recommended live broadcast channel for live broadcast is received is determined;

if a return instruction is received (that is, the user clicks a “start from the beginning” button in a current interface 500), the broadcast returns to a first live broadcast channel that is watched when entering the live broadcast interface for broadcast; or

if a recommendation instruction is received (that is, the user clicks “continue recommendation” button in a current interface 500), the corresponding live broadcast channels are live broadcast according to the sequence in the first recommended live broadcast channel list.

By setting the second prompt information, the user may select whether to start broadcast from the beginning or receive the recommended content, instead of forcible recommendation, thereby enhancing retention of the user.

In some exemplary embodiments, upon the step 101 of detecting that a trigger event occurs on a live broadcast interface, the method further includes:

whether the current live broadcast channel is opened via a link (for example, a push link and a search link) is determined, that is, whether the user opens the current live broadcast channel by clicking a link in pushed information or by clicking a link acquired by means of search, instead of clicking through a specific category and then selecting the current live broadcast channel; wherein in this case, an operation for continue switching channels in the preset live broadcast channel list or returning back to the live broadcast channel in the category may be defined, or an operation for not switching channels or returning back to the live broadcast channel may be defined in this scenario; however, when the user performs a switching operation, a live broadcast channel may be recommended to the user; and therefore the method further includes:

if the current living broadcast channel is opened via a link and the trigger event is an instruction for acquiring new content, a second recommended live broadcast channel list request is sent and a second recommended live broadcast list is received, the second recommended live broadcast list request including the link; and

corresponding live broadcast channels are broadcast according to a sequence in the second recommended live broadcast channel list.

In this way, with respect to a pushed or searched user, content to be pushed may be selected according to a vector characteristic of the live broadcast channel which the user enters via clicking, such that the recommended content better accommodates the preference of the user, and thus user experience is enhanced.

Further, in some other embodiments, the method for unlimitedly sliding to switch channels may further include:

if live broadcast channels in a live broadcast database are switched to the last live broadcast channel, live broadcast or continuously broadcast the live broadcast channels starting from a first live broadcast channel that is watched by the user; wherein the continuous broadcast herein refers to continuing broadcast the channel from the latest watching moment, and prompt information confirming whether to continue the broadcast may be given prior to the continuous broadcast, and if necessary, the broadcast is continued; or

a recommended media data list request is sent to the server and a second recommended live broadcast channel list is received, and corresponding media data is broadcast according to a sequence in the recommended media data list.

With the above method, when the user has watched all the live broadcast channels and still desires to watch other content, non-live broadcast programs matching with the preference of the user may be found from a media database, thereby further achieving the objective of unlimitedly sliding to switch channels.

In some exemplary embodiments, upon the step 101 of detecting that a trigger event occurs on a live broadcast interface, the method may further include the following steps:

if the trigger event is a return instruction, it is determined whether the current live broadcast channel is a first live broadcast channel in the live broadcast category; wherein the return instruction may be sent by a user via a touch gesture, or may be sent by means of clicking a button or a remote control; and in one exemplary embodiment, the gesture corresponding to return instruction may be swiping from the right to the left if the return instruction is sent via a touch gesture;

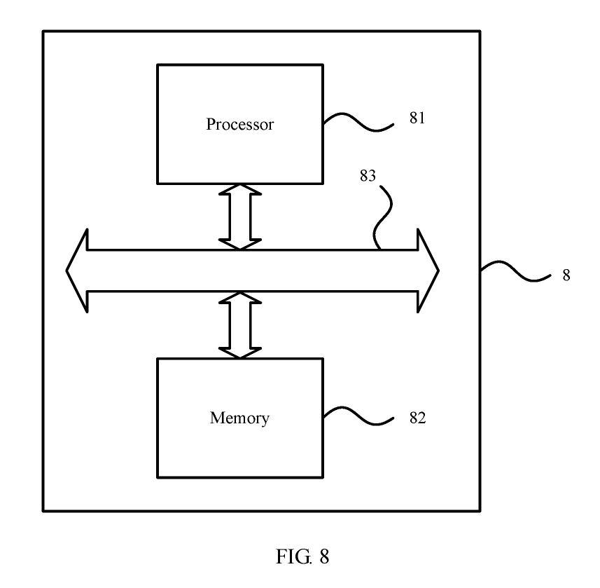

if the current live broadcast channel is the first live broadcast cannel, the returning is not performed and third prompt information 503 is sent (as illustrated in FIG. 7) for prompting the user that the returning operation may not be performed; or

if the current live broadcast channel is not the first live broadcast cannel, a previous live broadcast channel is returned to broadcast or continuous broadcast; wherein the continuous broadcast herein refers to continuing broadcast the channel from the latest watching moment, and prompt information confirming whether to continue the broadcast may be given prior to the continuous broadcast, and if necessary, the broadcast is continued.

With the above method, when the user desires return back to a previously watched live broadcast channel to continue watching the channel, a returning function is provided for the user, such that the user may simply returns to the previously watched channel, thereby enhancing user experience.

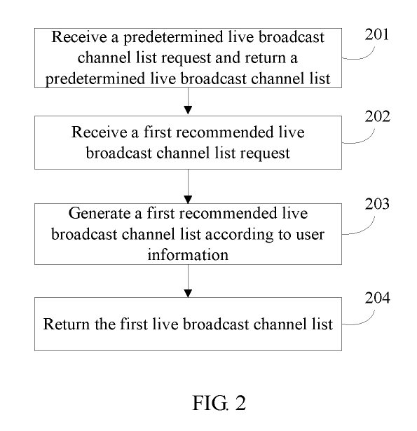

One exemplary embodiment aspect of the present disclosure provides a method capable of supporting a terminal to implement unlimitedly sliding to switch channels. As illustrated in FIG. 2, a schematic flowchart illustrating a method for unlimitedly sliding to switch channels according to another embodiment of the present disclosure is given.

The method for unlimitedly sliding to switch channels includes the following methods:

In Step 201: A preset live broadcast channel list request is received and a preset live broadcast channel list is returned.

The preset live broadcast channel list request is sent by using a terminal over which the live broadcast is being watched, and the preset live broadcast channel list is acquired according to a location of the current live broadcast channel, that is, according to whether the current live broadcast channel is located on the homepage or located in a live broadcast category, or the like.

In Step 202: A first recommended live broadcast channel list request is received, wherein the first recommended live broadcast channel list request carries user information.

The first recommended live broadcast channel list request indicates that the live broadcast channel being watched at that time is the last live broadcast channel, and thus more content needs to be recommended to the terminal.

In Step 203: The first recommended live broadcast channel list is generated according to the user information corresponding to the first recommended live broadcast channel list request.

In Step 204: The first live broadcast channel list is returned.

The step 203 of generating the first recommended live broadcast channel list according to the user information corresponding to the first recommended live broadcast channel list request may be implemented by the following steps:

a history watching record of the user is acquired according to the user information; wherein the history watching record may include all live broadcast channels watched by the user within a specific period of time, or even other multimedia programs, videos or the like, and content of the history watching record may be selected according to the actual needs;

a user characteristic vector is extracted according to the history watching record of the user; wherein the user characteristic vector refers to a vector extracted from the history watching record of the user and representing preference of the user, and the extraction may be specifically implemented by using the characteristic vector extraction method in the related art, which is thus not described herein any further; and

the user characteristic vector is matched with live broadcast channels in a live broadcast channel database to acquire a first recommended live broadcast channel list.

As seen from the above, with the method for unlimitedly sliding to switch channels according to the present disclosure, content of other live broadcast channels in which the user may be interested may be recommended to the user, such that more and richer content is exposed to the user. In this way, after the user watches all the live broadcast channels in a current category, live broadcast channels which the user is interested in may be seamlessly broadcasted under assistance of the terminal. This achieves the objective of unlimitedly sliding to switch channels, increases use duration and retention of the user and enhances user experience.

In some exemplary embodiments, upon the step 201 of receiving a preset live broadcast channel list request and returning a preset live broadcast channel list, the method may further include the following steps:

a second recommended live broadcast channel list request is received, wherein the second recommended live broadcast channel list request carries a link, and the recommended live broadcast channel list request indicates that the live broadcast channel is opened via the link, and content needs to be further recommended to the terminal;

a second recommended live broadcast channel list is acquired via the link; and

the second live broadcast channel list is returned.

The step of acquiring a second recommended live broadcast channel list via the link may further include the following steps:

a live broadcast channel characteristic vector is acquired via analysis according to the link; and

the live broadcast characteristic channel vector of the current live broadcast channel is matched with the live broadcast channels in the live broadcast channel database to acquire a second recommended live broadcast channel list.

In this way, with respect to a pushed or searched user, content to be pushed may be selected according to a vector characteristic of the live broadcast channel which the user enters via clicking, such that the recommended content better accommodates the preference of the user, and thus user experience is enhanced.

In addition, for better matching the data in the second recommended live broadcast channel list with the preference of the user, comprehensive matching may be performed with reference to the link and the user information, to thus acquire a more accurate second recommended live broadcast channel list.

Further, in some other embodiments, the method for unlimitedly sliding to switch channels further includes steps:

a recommended media data list request is received;

media data matching with a user characteristic vector is acquired from a media database;

the user characteristic vector is matched with the media data in the media data to acquire the recommended media data list; and

the recommended media data list is returned.

With the above method, when the user has watched all the live broadcast channels and still desires to watch other content, non-live broadcast programs matching with the preference of the user may be found from a media database, thereby further achieving the objective of unlimitedly sliding to switch channels.

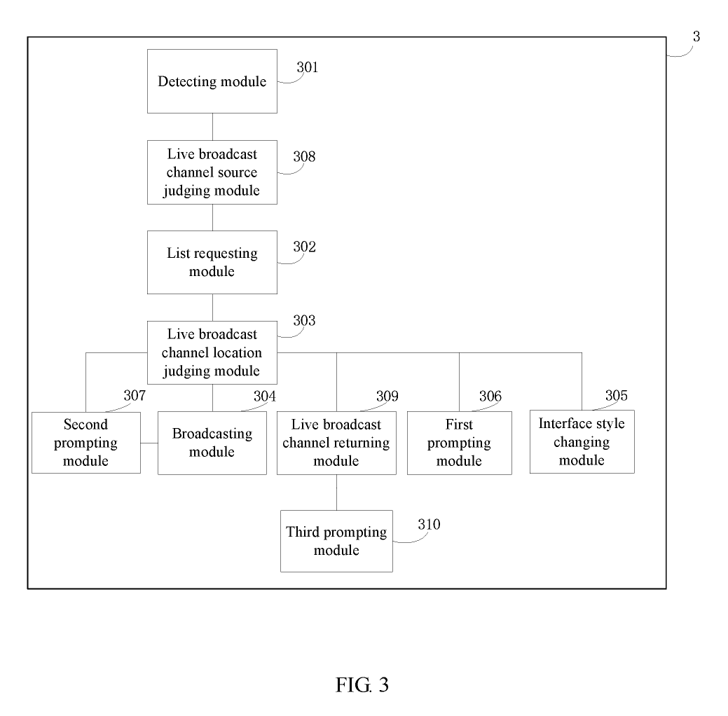

One exemplary embodiment of the present disclosure provides a terminal capable of implementing unlimited switching of channels. As illustrated in FIG. 3, a schematic structural diagram illustrating a terminal for unlimitedly sliding to switch channels in terms of modules according to one embodiment of the present disclosure is given.

The terminal for unlimitedly sliding to switch channels includes:

a detecting module 301, detects that a trigger event occurs in a live broadcast interface; for example, a touch signal applied to the live broadcast interface may be acquired via a touch screen of a device, or in another manner, for example, by means of clicking a button or a control signal sent by a remote control;

a list requesting module 302, sends a preset live broadcast channel list request to a server and receive a preset live broadcast channel list from the server, and if a current live broadcast channel is a last live broadcast channel, send a first recommended live broadcast channel list request to the server and receive a first recommended live broadcast channel list from the server; wherein the last live broadcast channel may be optionally the last live broadcast in the preset live broadcast channel list or the last unwatched live broadcast channel in the preset live broadcast channel list; and optionally, the first recommended live broadcast channel list is recommended to the user via a recommendation system according to the user's interests.

a live broadcast channel location judging module 303, determines whether a current live broadcast channel is a last live broadcast channel in the preset live broadcast channel list, if the trigger event is an instruction for acquiring new content; wherein the instruction for acquiring the new content may be sent by a user via a touch gesture, or may be sent by means of clicking a button or a remote control; and in one exemplary embodiment, the gesture corresponding to the instruction for acquiring the new content may be swiping from the right to the left if the instruction is sent via a touch gesture;

In some exemplary embodiment, the live broadcast channels are live broadcasted in a sequence in a preset live broadcast channel list corresponding to the categories of the channels (for example, sports, entertainment and the like categories); wherein the last live broadcast channel optionally refers to the last live broadcast channel in the preset live broadcast channel list or the last unwatched live broadcast channel in the preset live broadcast channel; herein, when the live broadcast channel entering live broadcast is a live broadcast channel in the intermediate portion of the preset live broadcast channel list, instead of the first live broadcast channel in the preset live broadcast channel list, after switching is made to the last live broadcast channel in the preset live broadcast channel list, since the live broadcast channels in the front portion of the preset live broadcast channel list are not broadcast, the last unwatched live broadcast channel refers to a live broadcast channel prior to the live broadcast channel entering live broadcast in the preset live broadcast channel list; the preset live broadcast channel list is acquired from the server after the preset live broadcast channel list request is sent to the server; and

a broadcasting module 304, switches to a next live broadcast channel for live broadcast, if the current live broadcast channel is not the last live broadcast channel in the preset live broadcast channel, and broadcasts corresponding live broadcast channels according to a sequence in the first recommended live broadcast channel list, if the current live broadcast channel is the last live broadcast channel in the preset live broadcast channel.

As seen from the above, with the terminal for unlimitedly sliding to switch channels, it is determined whether a user needs to acquire new content by detecting a trigger event; if the user needs to acquire the new content, it is determined whether a current live broadcast channel is a last live broadcast channel (that is, no more content may be provided subsequently); and if the current live broadcast channel is the last live broadcast channel, content of other live broadcast channels in which the user may be interested may be recommended to the user, such that more and richer content is exposed to the user. This achieves the objective of unlimitedly sliding to switch channels, increases use duration and retention of the user and enhances user experience.

Further, in some exemplary embodiments, the terminal for unlimitedly sliding to switch channels further includes an interface style changing module and/or a first prompting module; wherein

the live broadcast channel location judging module 303 is further determines whether the live broadcast channel switched is a last live broadcast channel in the live broadcast channel category thereof; wherein the method for judging whether the live broadcast channel switched is the last live broadcast channel may be referenced to the method described in the above embodiment, which is thus not described herein any further;

If the live broadcast channel switched is the last live broadcast channel, the interface style changing module 305 changes a current interface style and/or the first prompting module 306 sends first prompt information.

The changing the current interface style may be switching the theme of the current interface and selecting a theme which has a prominent color and color matching, thereby achieving the effect of prompting. As illustrated in FIG. 5, the text prompt may employ lighter colors or be subjected to transparent treatment, to ensuring watching quality for the user.

After switching of the live broadcast channel, it is determined whether the current live broadcast channel is the last live broadcast channel, and when it is determined that the current live broadcast channel is the last live broadcast channel, the user is notified that the current live broadcast channel is the last broadcast channel and content would be provided for the user in case of further channel switching, thereby guiding the user to watch the recommended content and facilitating user's watching.

In some exemplary embodiments, the terminal for unlimitedly sliding to switch channels further includes a second prompting module 307, configured to send second prompt information 502 (as illustrated in FIG. 6) for prompting the user that a live broadcast channel would be recommended if the user further switches the channel;

the detecting module 301 sends second prompt information, and determines whether a return instruction for returning to an initial live broadcast channel is received or a recommendation instruction for acquiring a recommended live broadcast channel for live broadcast is received;

if a return instruction is received (that is, the user clicks a “start from the beginning” in a current interface 500), the broadcasting module 304 returns to a first live broadcast channel that is watched when entering the live broadcast interface for broadcast; or

if a recommendation instruction is received (that is, the user clicks “continue recommendation” button in a current interface 500), the broadcasting module 304 broadcasts the corresponding live broadcast channels according to the sequence in the first recommended live broadcast channel list.

By setting the second prompt information, the user may select whether to start broadcast from the beginning or receive the recommended content, instead of forcible recommendation, thereby enhancing retention of the user.

In some exemplary embodiments, the terminal for unlimitedly sliding to switch channels further includes a live broadcast channel source judging module 308, determines whether the current live broadcast channel is opened via a link (for example, a push link and a search link), that is, whether the user opens the current live broadcast channel by clicking a link in pushed information or by clicking a link acquired by means of search, instead of clicking through a specific category and then selecting the current live broadcast channel; wherein in this case, an operation for continue switching channels in the preset live broadcast channel list or returning back to the live broadcast channel in the category may be defined, or an operation for not switching channels or returning back to the live broadcast channel may be defined in this scenario; however, when the user performs a switching operation, a live broadcast channel may be recommended to the user; and therefore, in the terminal for unlimitedly sliding to switch channels:

if the current living broadcast channel is opened via a pushed link or a search link and the trigger event is an instruction for acquiring new content, the list requesting module 302 is further configured to send a second recommended live broadcast channel list request to the server and receiving a second recommended live broadcast list from the server; and

the broadcasting module 304 broadcasts corresponding live broadcast channels according to a sequence in the second recommended live broadcast channel list.

In this way, with respect to a pushed or searched user, content to be pushed may be selected according to a vector characteristic of the live broadcast channel which the user enters via clicking, such that the recommended content better accommodates the preference of the user, and thus user experience is enhanced.

Further, in some embodiments, the live broadcast channel location judging module 303 determines whether the live broadcast channel switched is the last live broadcast channel in the preset live broadcast channel list; and

if live broadcast channels in a live broadcast database are switched to the last live broadcast channel, the broadcasting module 304 broadcasts or continuously broadcasts the live broadcast channels starting from a first live broadcast channel that is watched by the user; wherein the continuous broadcast herein refers to continuing broadcast the channel from the latest watching moment, and prompt information confirming whether to continue the broadcast may be given prior to the continuous broadcast, and if necessary, the broadcast is continued; or

the list requesting module 302 sends a recommended media data list request to the server and receive the second recommended live broadcast channel list from the server; and the broadcasting module 304 broadcasts corresponding media data according to a sequence in the recommended media data list.

With the above method, when the user has watched all the live broadcast channels and still desires to watch other content, non-live broadcast programs matching with the preference of the user may be found from a media database, thereby further achieving the objective of unlimitedly sliding to switch channels.

In some exemplary embodiments, the apparatus further includes a live broadcast channel returning module 309 and a third promoting module 310; wherein

if the trigger event is a return instruction, the live broadcast channel location judging module 302 determines whether the current live broadcast channel is a first live broadcast channel in the live broadcast category; wherein the return instruction may be sent by a user via a touch gesture, or may be sent by means of clicking a button or a remote control; and in one exemplary embodiment, the gesture corresponding to return instruction may be swiping from the right to the left if the return instruction is sent via a touch gesture;

if the current live broadcast channel is the first live broadcast cannel, returning is not performed and the third prompting module 310 sends third prompt information 503 (as illustrated in FIG. 7) for prompting the user that the returning operation may not be performed; or

if the current live broadcast channel is not the first live broadcast cannel, the live broadcast channel returning module 309 returns to a previous live broadcast channel or continuously broadcast the live broadcast channel. The continuous broadcast herein refers to continuing broadcasting the channel from the latest watching moment, and prompt information confirming whether to continue the broadcast may be given prior to the continuous broadcast, and if necessary, the broadcast is continued.

With the above method, when the user desires return back to a previously watched live broadcast channel to continue watching the channel, a returning function is provided for the user, such that the user may simply returns to the previously watched channel, thereby enhancing user experience.

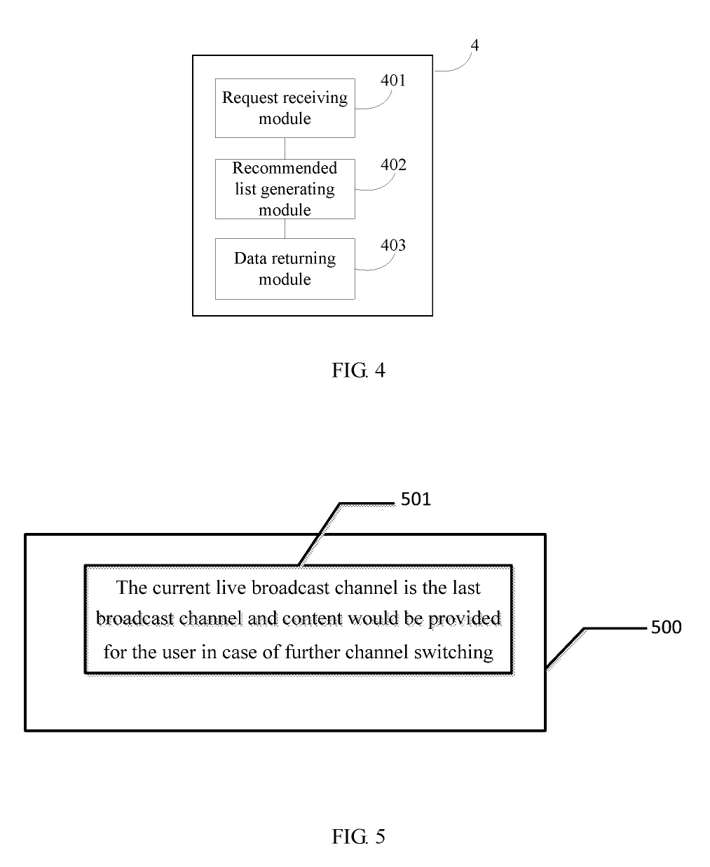

One exemplary embodiment of the present disclosure provides a server capable of implementing unlimited switching of channels. As illustrated in FIG. 4, a schematic structural diagram illustrating a server for unlimitedly sliding to switch channels in terms of modules according to one embodiment of the present disclosure is given.

The server for unlimitedly sliding to switch channels includes:

a request receiving module 401, receives a preset live broadcast channel list request and a first recommended live broadcast channel list request, the first recommended live broadcast channel list request carrying user information; wherein the preset live broadcast channel list request is sent by using a terminal over which the live broadcast is being watched, and the preset live broadcast channel list is acquired according to a location of the current live broadcast channel, that is, according to whether the current live broadcast channel is located on the homepage or located in a live broadcast category, or the like;

a recommended list generating module 402, generates the first recommended live broadcast channel list according to the user information corresponding to the first recommended live broadcast channel list request; wherein the first recommended live broadcast channel list request indicates that the live broadcast channel being watched at that time is the last live broadcast channel, and thus more content needs to be recommended to the terminal; and

a data returning module 403, returns a preset live broadcast channel list, and returns the first recommended live broadcast channel list.

The first recommended live broadcast channel list may be acquired further by the following steps:

a history watching record of the user is acquired according to the user information; wherein the history watching record may include all live broadcast channels watched by the user within a specific period of time, or even other multimedia programs, videos or the like, and content of the history watching record may be selected according to the actual needs;

a user characteristic vector is extracted according to the history watching record of the user; wherein the user characteristic vector refers to a vector extracted from the history watching record of the user and representing preference of the user, and the extraction may be specifically implemented by using the characteristic vector extraction method in the related art, which is thus not described herein any further; and

the user characteristic vector is matched with live broadcast channels in a live broadcast channel database to acquire a first recommended live broadcast channel list.

As seen from the above, with the server for unlimitedly sliding to switch channels according to the present disclosure, content of other live broadcast channels in which the user may be interested may be recommended to the user, such that more and richer content is exposed to the user. In this way, after the user watches all the live broadcast channels in a current category, live broadcast channels which the user is interested in may be seamlessly broadcasted under assistance of the terminal. This achieves the objective of unlimitedly sliding to switch channels, increases use duration and retention of the user and enhances user experience.

In some exemplary embodiments, the request receiving module 401 receives a second recommended live broadcast channel list request, wherein the second recommended live broadcast channel list request carries a link, and the recommended live broadcast channel list request indicates that the live broadcast channel is opened via the link, and content needs to be further recommended to the terminal;

the recommended list generating module 402 acquires a second recommended live broadcast channel list via the link; and

the data returning module 403 returns the second live broadcast channel list.

The second recommended live broadcast channel list may be acquired by the following steps:

a live broadcast channel characteristic vector is acquired via analysis according to the link; and

the live broadcast characteristic channel vector of the current live broadcast channel is matched with the live broadcast channels in the live broadcast channel database to acquire a second recommended live broadcast channel list.

In this way, with respect to a pushed or searched user, content to be pushed may be selected according to a vector characteristic of the live broadcast channel which the user enters via clicking, such that the recommended content better accommodates the preference of the user, and thus user experience is enhanced.

In addition, for better matching the data in the second recommended live broadcast channel list with the preference of the user, comprehensive matching may be performed with reference to the link and the user information, to thus acquire a more accurate second recommended live broadcast channel list.

Further, in some embodiments, the request receiving module 401 receives a recommended media data list request, the recommended media data list request carrying user information;

the recommended list generating module 402 acquires media data matching with a user characteristic vector from a media database, and match the user characteristic vector with the media data in the media data to acquire the recommended media data list; and

the data returning module 403 returns the recommended media data list.

With the above method, when the user has watched all the live broadcast channels and still desires to watch other content, non-live broadcast programs matching with the preference of the user may be found from a media database, thereby further achieving the objective of unlimitedly sliding to switch channels.

One exemplary embodiment the present disclosure provides a system capable of implementing unlimited switching of channels. The system for unlimitedly sliding to switch channels includes the terminal as described in the above embodiment and the server as described in the above embodiment.

One exemplary embodiment the present disclosure provides a non-volatile computer readable storage medium, which is configured to store computer executable instructions. When the instructions are executed by one or a plurality of central processors, for example, a processor may be caused to perform the steps in the above method embodiments, for example, steps 101 to 106 illustrated in FIG. 1, or the processor may be caused to implement the functions of the units in the above apparatus embodiments, for example, the functions of units 301 to 310 illustrated in FIG. 3.

One exemplary embodiment the present disclosure provides a non-volatile computer readable storage medium, which is configured to store computer executable instructions. When the instructions are executed by one or a plurality of central processors, for example, a processor may be caused to perform the steps in the above method embodiments, for example, steps 201 to 204 illustrated in FIG. 2, or the processor may be caused to implement the functions of the units in the above apparatus embodiments, for example, the functions of units 401 to 403 illustrated in FIG. 4.

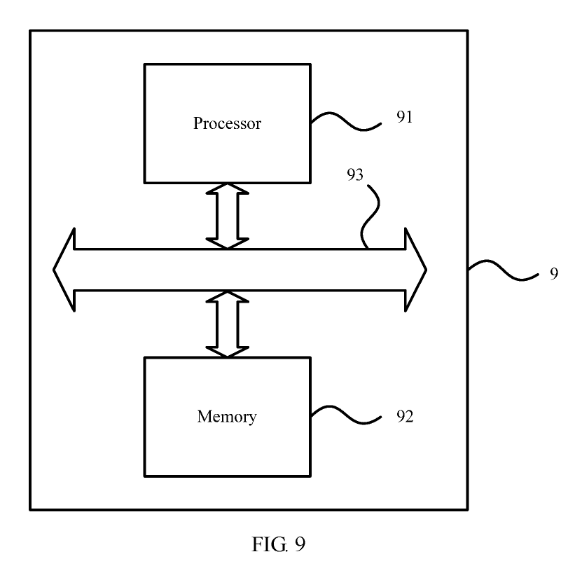

A terminal and server for unlimitedly sliding to switch channels according to the embodiments of the present application are described in detail hereinafter with reference to FIG. 8 and FIG. 9.

FIG. 8 is a schematic block diagram illustrating a terminal 8 for unlimitedly switching channels according to an embodiment of the present disclosure. As illustrated in FIG. 8, the terminal 8 for unlimitedly sliding to switch channels includes: a processor 81, a memory 82 and a bus system 83. The processor 81 and the memory 82 are connected to each other via the bus system 83, the memory 82 is configured to store instructions, and the processor 81 is configured to execute the instructions stored in the memory 82 to:

detect that a trigger event occurs on a live broadcast interface;

send a preset live broadcast channel list request to a server and receiving a preset live broadcast channel list from the server;

if the trigger event is an instruction for acquiring new content, determine whether a current live broadcast channel is a last live broadcast channel in the preset live broadcast channel list;

if the current live broadcast channel is not the last live broadcast channel in the preset live broadcast channel, switch to a next live broadcast channel for live broadcast;

if the current live broadcast channel is the last live broadcast channel in the preset live broadcast channel, send a first recommended live broadcast channel list request to the server and receive a first recommended live broadcast channel list from the server; and

live broadcast corresponding live broadcast channels according to a sequence in the first recommended live broadcast channel list.

The memory 82 of the terminal 8 for unlimitedly sliding to switch channels may be a non-volatile computer readable storage medium, which is configured to store computer executable instructions. When the instructions are executed by one or a plurality of central processors, for example, a processor may be caused to perform the steps in the above method embodiments, for example, steps 101 to 106 illustrated in FIG. 1, or the processor may be caused to implement the functions of the units in the above apparatus embodiments, for example, the functions of units 301 to 310 illustrated in FIG. 3. The computer executable instructions may also be stored and/or transmitted in any non-volatile computer readable storage medium, such that these instructions are used by an instruction executing system, apparatus or device, or used in combination with the instruction executing system, apparatus or device. The instruction executing system, apparatus or device may be, for example, a computer-based system, a system comprising a processor or another system capable of acquiring instructions from the instruction executing system, apparatus or device and executing the instructions. For the purpose of this specification, the “non-volatile computer readable storage medium” may be any tangible medium including or storing computer executable instructions. The computer executable instructions may be used by the instruction executing system, apparatus or device, or used in combination with the executing system, apparatus or device. The non-volatile computer readable storage medium may include, but not limited to, a magnetic, optical and/or semiconductor storage device. Examples of these storage devices include a magnetic disk, an optical disc based on CD, DVD and Blu-ray technology, and permanent solid memory (for example, a flash memory, a solid driver and the like).

It should be understood that in the embodiments of the present application, the processor 81 may be a central processing unit (CPU). The processor 81 may be a general processor, a digital signal processor (DSP), an application specific integrated circuit (ASIC), a field programmable gate array (FPGA) or another programmable logic device, a discrete gate or transistor logic device, or a discrete hardware component. The general processor may be a microprocessor or any customary processor or the like.

In addition to a data bus, the bus system 83 may further include a power bus, a control bus, a state signal bus and the like. However, for clarity of description, various buses are all marked as the bus system 83.

In the embodiments of the present disclosure, the terminal for unlimitedly sliding to switch channels is not limited to the components and configurations as illustrated in FIG. 8, but may further include other or additional components having a plurality of configurations.

During the implementation, various steps in the above method and various modules in the above apparatus may be implemented by means of an integrated logic circuit in the processor 81 or by means of software. The steps in the method and the units in the apparatus disclosed in the embodiments of the present disclosure may be directly embodied as being implemented by a hardware processor, or implemented by a combination of hardware in the processor and other software modules. The software module may be located in a random memory, a flash memory, a read-only memory, a programmable read-only memory, an electrically erasable programmable memory, a register or the like storage medium commonly known in the art. The storage medium is located in the memory 82. The processor 81 reads the information stored in the memory 82 and performs the steps of the above method in combination with the hardware thereof. For brevity of description, the details are not given herein any further.

With the terminal for unlimitedly sliding to switch channels according to the embodiments of the present disclosure, it is determined whether a user needs to acquire new content by detecting a trigger event; if the user needs to acquire the new content, it is determined whether a current live broadcast channel is a last live broadcast channel (that is, no more content may be provided subsequently); and if the current live broadcast channel is the last live broadcast channel, content of other live broadcast channels in which the user may be interested may be recommended to the user, such that more and richer content is exposed to the user. This achieves the objective of unlimitedly sliding to switch channels, increases use duration and retention of the user and enhances user experience.

FIG. 9 is a schematic block diagram illustrating a server 9 for unlimitedly sliding to switch channels according to an embodiment of the present disclosure. As illustrated in FIG. 9, the server 9 for unlimitedly sliding to switch channels includes: a processor 91, a memory 92 and a bus system 93. The processor 91 and the memory 92 are connected to each other via the bus system 93, the memory 92 is configured to store instructions, and the processor 91 is configured to execute the instructions stored in the memory 92 to:

receive a preset live broadcast channel list request and returning a preset live broadcast channel list;

receive a first recommended live broadcast channel list request, the first recommended live broadcast channel list request carrying user information; and

generate a first recommended live broadcast channel list according to the user information corresponding to the first recommended live broadcast channel list request, and return the first recommended live broadcast channel list.

The memory 92 of the terminal 9 for unlimitedly sliding to switch channels may be a non-volatile computer readable storage medium, which is configured to store computer executable instructions. When the instructions are executed by one or a plurality of central processors, for example, a processor may be caused to perform the steps in the above method embodiments, for example, steps 201 to 204 illustrated in FIG. 2, or the processor may be caused to implement the functions of the units in the above apparatus embodiments, for example, the functions of units 401 to 403 illustrated in FIG. 4. The computer executable instructions may also be stored and/or transmitted in any non-volatile computer readable storage medium, such that these instructions are used by an instruction executing system, apparatus or device, or used in combination with the instruction executing system, apparatus or device. The instruction executing system, apparatus or device may be, for example, a computer-based system, a system comprising a processor or another system capable of acquiring instructions from the instruction executing system, apparatus or device and executing the instructions. For the purpose of this specification, the “non-volatile computer readable storage medium” may be any tangible medium including or storing computer executable instructions. The computer executable instructions may be used by the instruction executing system, apparatus or device, or used in combination with the executing system, apparatus or device. The non-volatile computer readable storage medium may include, but not limited to, a magnetic, optical and/or semiconductor storage device. Examples of these storage devices include a magnetic disk, an optical disc based on CD, DVD and Blu-ray technology, and permanent solid memory (for example, a flash memory, a solid driver and the like).

It should be understood that in the embodiments of the present application, the processor 91 may be a central processing unit (CPU). The processor 91 may be a general processor, a digital signal processor (DSP), an application specific integrated circuit (ASIC), a field programmable gate array (FPGA) or another programmable logic device, a discrete gate or transistor logic device, or a discrete hardware component. The general processor may be a microprocessor or any customary processor or the like.

In addition to a data bus, the bus system 93 may further include a power bus, a control bus, a state signal bus and the like. However, for clarity of description, various buses are all marked as the bus system 93.

In the embodiments of the present disclosure, the server for unlimitedly sliding to switch channels is not limited to the components and configurations as illustrated in FIG. 9, but may further include other or additional components having a plurality of configurations.

During the implementation, various steps in the above method and various modules in the above apparatus may be implemented by means of an integrated logic circuit in the processor 91 or by means of software. The steps in the method and the modules in the apparatus disclosed in the embodiment of the present disclosure may be directly embodied as being implemented by a hardware processor, or implemented by a combination of hardware in the processor and other software modules. The software module may be located in a random memory, a flash memory, a read-only memory, a programmable read-only memory, an electrically erasable programmable memory, a register or the like storage medium commonly known in the art. The storage medium is located in the memory 92. The processor 91 reads the information stored in the memory 92 and performs the steps of the above method in combination with the hardware thereof. For brevity of description, the details are not given herein any further.

With the server for unlimitedly sliding to switch channels according the embodiment of the present disclosure, content of other live broadcast channels in which the user may be interested may be recommended to the user, such that more and richer content is exposed to the user. In this way, after the user watches all the live broadcast channels in a current category, live broadcast channels which the user is interested in may be seamlessly broadcasted under assistance of the terminal. This achieves the objective of unlimitedly sliding to switch channels, increases use duration and retention of the user and enhances user experience.

Persons of ordinary skill in the art should understand that the discussion of any of the above embodiments is exemplary, and is not intended to imply that the scope of the present disclosure (including the claims) is limited to these exemplary embodiments. The above embodiments, or the technical features in different embodiments may be combined, and various modifications may be made to different aspects of the present disclosure, which are not described in detail for brevity. Therefore, any omission, modification, equivalent replacement, or improvement made without departing from the spirit and principle of the present disclosure should fall within the protection scope of the present disclosure.

What is claimed is:

1. A method for unlimitedly sliding to switch channels, comprising:
at an electronic device,
detecting that a trigger event occurs on a live broadcast interface;
sending a preset live broadcast channel list request to a server and receiving a preset live broadcast channel list from the server;
determining whether a current live broadcast channel is a last live broadcast channel in the preset live broadcast channel list, if the trigger event is an instruction for acquiring new content;
switching to a next live broadcast channel for broadcasting, if the current live broadcast channel is not the last live broadcast channel in the preset live broadcast channel;
sending a first recommended live broadcast channel list request to the server and receiving a first recommended live broadcast channel list from the server, if the current live broadcast channel is the last live broadcast channel in the preset live broadcast channel; and
broadcasting corresponding live broadcast channels according to a sequence in the first recommended live broadcast channel list.

2. The method according to claim 1, wherein after switching to a next live broadcast channel for broadcasting, the method further comprises:
determining whether the live broadcast channel switched is the last live broadcast channel in the preset live broadcast channel list; and
changing a current interface style and/or sending first prompt information, if the live broadcast channel switched is the last live broadcast channel.

3. The method according to claim 1, wherein before broadcasting corresponding live broadcast channels according to a sequence in the first recommended live broadcast channel list, the method further comprises:
sending second prompt information, and determining whether a return instruction for returning to an initial live broadcast channel is received or a recommendation instruction for acquiring a recommended live broadcast channel for live broadcast is received;
returning to a first live broadcast channel that is watched when entering the live broadcast interface for broadcasting, if a return instruction is received; or
broadcasting the corresponding live broadcast channels according to the sequence in the first recommended live broadcast channel list if a recommendation instruction is received.

4. The method according to claim 1, wherein after the detecting a trigger event occurs on a live broadcast interface, the method further comprises:
determining whether the current live broadcast channel is opened via a link;
sending a second recommended live broadcast channel list request to the server and receiving a second recommended live broadcast list, the second recommended live broadcast list request comprising the link, if the current living broadcast channel is opened via a link and the trigger event is an instruction for acquiring new content; and
broadcasting corresponding live broadcast channels according to a sequence in the second recommended live broadcast channel list.

5. The method according to claim 4, further comprising:
rebroadcasting or resuming broadcast the live broadcast channels starting from a first live broadcast channel that is watched by the user, if live broadcast channels in a live broadcast database are switched to the last live broadcast channel; or
sending a recommended media data list request to the server and receiving a recommended media data list, and broadcasting corresponding media data according to a sequence in the recommended media data list.

6. An electronic device for unlimitedly sliding to switch channels, comprising:
at least one processor, and
a memory communicably connected with the at least one processor and for storing instructions executable by the at least one processor. Wherein execution of the instructions by the at least one processor causes the at least one processor to:
detect that a trigger event occurs on a live broadcast interface;
send a preset live broadcast channel list request to a server and receive a preset live broadcast channel list from the server, determine whether a current live broadcast channel is a last live broadcast channel in the preset live broadcast channel list, if the trigger event is an instruction for acquiring new content; switch to a next live broadcast channel for broadcasting, if the current live broadcast channel is not the last live broadcast channel in the preset live broadcast channel,
send a first recommended live broadcast channel list request to the server and receive a first recommended live broadcast channel list from the server, if the current live broadcast channel is the last live broadcast channel in the preset live broadcast channel; and
broadcast corresponding live broadcast channels according to a sequence in the first recommended live broadcast channel list.

7. The electronic device according to claim 6, wherein the at least one processor is further caused to:
determine whether the live broadcast channel switched is the last live broadcast channel in the preset live broadcast channel list; and
change a current interface style and/or send first prompt information, if the live broadcast channel switched is the last live broadcast channel.

8. The electronic device according to claim 6, wherein the at least one processor is further caused to:
send second prompt information, and determine whether a return instruction for returning to an initial live broadcast channel is received or a recommendation instruction for acquiring a recommended live broadcast channel for live broadcast is received;
return to a first live broadcast channel that is watched when entering the live broadcast interface for broadcasting, if a return instruction is received; or
broadcasting the corresponding live broadcast channels according to the sequence in the first recommended live broadcast channel list, if a recommendation instruction is received.

9. The electronic device according to claim 8, wherein the at least one processor is further caused to:
determine whether the current live broadcast channel is opened via a pushed link or a search link; send a second recommended live broadcast channel list request and receive a second recommended live broadcast list, the second recommended live broadcast list request comprising the link, if the current living broadcast channel is opened via a pushed link or a search link and the trigger event is an instruction for acquiring new content; and
broadcasting corresponding live broadcast channels according to a sequence in the second recommended live broadcast channel list.

10. The electronic device according to claim 9, wherein the at least one processor is further caused to:
determine whether live broadcast channels in a live broadcast database are switched to the last live broadcast channel; rebroadcasting or resuming broadcast the live broadcast channels starting from a first live broadcast channel that is watched by the user, if the live broadcast channels in the live broadcast database are switched to the last live broadcast channel; or
send a recommended media data list request to the server and receive a recommended media data list; and
broadcast corresponding media data according to a sequence in the recommended media data list.

11. An electronic device for unlimitedly sliding to switch channels, comprising:
at least one processor, and
a memory communicably connected with the at least one processor and for storing instructions executable by the at least one processor. Wherein execution of the instructions by the at least one processor causes the at least one processor to:
receive a preset live broadcast channel list request and return a preset live broadcast channel list;
receive a first recommended live broadcast channel list request, the first recommended live broadcast channel list request carrying user information; and
generate a first recommended live broadcast channel list according to the user information corresponding to the first recommended live broadcast channel list request, and return the first recommended live broadcast channel list.

12. The electronic device according to claim 11, wherein the at least one processor is further caused to:
receive a second recommended live broadcast channel list request, the second recommended live broadcast channel list request carrying a link;
acquire a second recommended live broadcast channel list via the link; and
return the second live broadcast channel list.

13. The electronic device according to claim 12, wherein the at least one processor is further caused to:
receive a recommended media data list request;
acquire media data matched with a user characteristic vector from a media database;
match the user characteristic vector with the media data in the media data base to acquire the recommended media data list; and
return the recommended media data list.
